(19) United States
(12) Patent Application Publication
(10) Pub. No.: US 2016/0086182 A1
(43) Pub. Date: Mar. 24, 2016

(54) System, Method and Apparatus to Detect Fraud in Travel Transactions

(71) Applicant: MasterCard International Incorporated, Purchase, NY (US)

(72) Inventors: Justin Xavier Howe, San Francisco, CA (US); Jose Luis Yofe, Danbury, CT (US)

(21) Appl. No.: 14/495,165

(22) Filed: Sep. 24, 2014

(51) Int. Cl. G06Q 20/40

(52) U.S. Cl. CPC G06Q 20/4016

(57) ABSTRACT

A system, method, and computer-readable storage medium to detect payment card fraud in travel transactions.

### BACKGROUND

1. Field of the Disclosure

Aspects of the disclosure relate in general to financial services. Aspects include an apparatus, system, method and computer-readable storage medium to detect payment card fraud in travel transactions.

2. Description of the Related Art

A payment card is a card that can be used by a cardholder and accepted by a merchant to make a payment for a purchase or in payment of some other obligation. Payment cards include credit cards, debit cards, charge cards, and Automated Teller Machine (ATM) cards.

Payment cards provide the clients of a financial institution (“cardholders”) with the ability to pay for goods and services without the inconvenience of using cash. For example, traditionally, whenever travelers leave home, they carried large amounts of cash to cover journey expenditures, such as transportation, lodging, and food. Payment cards eliminate the need for carrying large amounts of currency. Moreover, in international travel situations, payment cards obviate the hassle of changing currency.

Travel is expensive. As a result, payment cards are frequently used to pay for transportation tickets, such as airline or rail tickets. By using a payment card, a cardholder avoids using large amounts of cash, which reduces the risk of loss through theft.

### SUMMARY

Embodiments include a system, device, method and computer-readable medium to detect payment card fraud in travel transactions.

In one embodiment, a system comprises a network interface and a processor. The network interface is configured to receive payment card transaction data from an acquirer or travel transaction data from a Global Distribution System (GDS). The payment card transaction or travel transaction data contains personally identifiable information. Using a cardholder identifier, the processor retrieves a cardholder record from a database stored on a non-transitory computer-readable storage medium. The processor compares the personally identifiable information with the cardholder record to determine whether the cardholder participated in the payment card transaction. When it is determined that the cardholder participated in the payment card transaction, a status of the payment card transaction is flagged as not-fraudulent.

### BRIEF DESCRIPTION OF THE DRAWINGS

FIG. 1 is a block diagram illustrating a system to detect payment card fraud in travel transactions.

FIG. 2 is an expanded block diagram of an exemplary embodiment of a server architecture of a payment card network embodiment configured to detect payment card fraud in travel transactions.

FIG. 3 illustrates a method to detect payment card fraud in travel transactions.

### DETAILED DESCRIPTION

One aspect of the disclosure includes that the realization that payment card transaction addenda (“addenda”), Global Distribution System (GDS) data, or Billing and Settlement Plan (BSP) data may be used to verify cardholder transaction information. In travel transactions, addenda, GDS, or BSP information may include personally identifiable information (PII). Personally identifiable information may include information that can be used on its own or with other information to identify, contact, or locate a single person, or to identify an individual in context. For example, PII may be any information about an individual, including, but not limited to: (1) any information that can be used to distinguish or trace an individual's identity, such as name, social security number, frequent traveler number (e.g., frequent flier number), customer identifier, date and place of birth, mother's maiden name, or biometric records; (2) any other information that is linked or linkable to an individual, such as educational, financial, and employment information, or (3) payment card numbers.

Another aspect of the disclosure includes the realization that in a legitimate (i.e. not-fraudulent) travel payment transaction, any personally identifiable information should likely indicate travel by the cardholder or someone cohabitating with the cardholder or previously cohabitating with the cardholder—for example, a spouse, children or other family of the cardholder.

It is understood by those familiar with the art that the term “payment card” includes credit cards, debit cards, charge cards, and Automated Teller Machine (ATM) cards. In addition to payment cards, it is understood by those familiar with the art that the embodiments described herein apply equally to payments via mobile devices (such as key fobs, mobile phones, tablet computers, and the like), electronic wallets, virtual payment cards, cloud-based payment devices, cashless payment devices/methods, or computers.

Embodiments of the present disclosure detect payment card fraud in travel transactions through analyzing personally identifiable information in travel-related payment card addenda, GDS, or BSP information. In some embodiments, a system may verify that transactions are legitimate because the travel purchase transaction involves the cardholder. In yet other embodiments, the system may detect potentially fraudulent transactions because the travel purchased does not involve the cardholder or anyone living with the cardholder.

The systems and processes are not limited to the specific embodiments described herein. In addition, components of each system and each process can be practiced independently and separately from other components and processes described herein. Each component and process also can be used in combination with other assembly packages and processes.

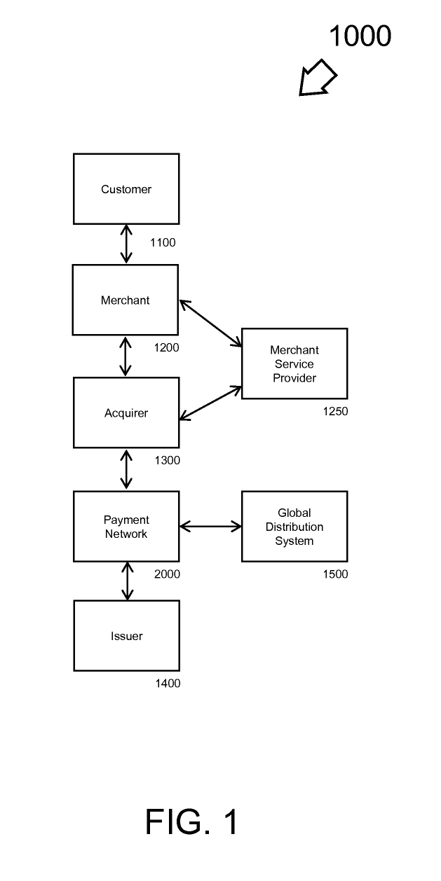

FIG. 1 is a block diagram 1000 illustrating a financial transaction using a payment card payment system configured to detect payment card fraud in travel transactions.

It is understood that the fraud detection may occur at either at an issuer 1400 or at a payment network 2000. For sake of example only, the present disclosure will describe a payment network-based system, such as the payment system using the MasterCard® interchange, Cirrus® network, or Maestro®. The MasterCard interchange is a proprietary communications standard promulgated by MasterCard International Incorporated of Purchase, N.Y., for the exchange of financial transaction data between financial institutions that are customers of MasterCard International Incorporated. Cirrus is a worldwide interbank network operated by MasterCard International Incorporated linking debit and payment cards to a network of ATMs throughout the world. Maestro is a multi-national debit card service owned by MasterCard International Incorporated.

In a financial payment system, a financial institution called the “issuer” 1400 issues a payment card to a consumer 1100, who uses a payment card to tender payment at a merchant 1200 or withdraw cash from an Automated Teller Machine. As customer 1100 is a cardholder, for the purposes of this disclosure, the terms “customer” and “cardholder” are the same.

In one example, a cardholder 1100 presents the payment card at a merchant 1200. Typically, a merchant 1200 may be a vendor, service provider, or any other provider of goods or services; in this particular example, the merchant 1200 is a provider of a travel-related service, such as an airline, rental car company, rail service, or any other travel-related service known in the art.

The merchant 1200 is affiliated with a financial institution. This financial institution is usually called the “acquiring bank,” “merchant bank” or “acquirer” 1300. When a payment card is tendered at a merchant 1200, the merchant 1200 electronically requests authorization from the acquirer 1300 for the amount of the purchase. The request is performed electronically with the consumer's account information from the magnetic stripe on the payment card or for CHIP enabled payment cards, via the computer chip imbedded within the card. The account information and transaction information are forwarded to transaction processing computers of the acquirer 1300.

Alternatively, an acquirer 1300 may authorize a third party to perform transaction processing on its behalf. In this case, the merchant 1200 will be configured to communicate with the third party. Such a third party is usually called a “merchant service provider” or an “acquiring processor.”

Furthermore in some embodiments, a merchant service provider 1250 may connect to an acquirer 1300 on behalf of merchant 1200.

Using a payment network 2000, the computers of the acquirer 1300 or the merchant processor will communicate via an interbank network authorization message or PIN network with the computers of the issuer 1400 to determine whether the consumer's account is in good standing and whether the transaction is likely to be fraudulent.

When a request for authorization is accepted, the available credit balance of cardholder's account is decreased, and a payment is later made to merchant 1200 via acquirer 1300.

After a transaction is captured, the transaction is communicated between the merchant 1200, the acquirer 1300, and the issuer 1400. In some embodiments, there may be a clearing process and a settlement process. A clearing process is a reconciliation process, helping issuers/acquirers learn about the amount to be transferred. A settlement process is a funds transfer process. Typically the clearing process and settlement process are generally performed as batch processes. During the clearing process, the merchant 1200 or acquirer 1300 provides encoded details of the transaction to the payment network 2000. The transaction detail includes interchange rate/category for the transaction, the time/date of the transaction, the type of transaction, where the transaction occurred, the amount of the transaction and the Primary Account Number of the payment card involved in the transaction. Additionally, merchants may attach addendum details to the transaction information. Such addendum information may include, but is not limited to:

Passenger Transport Detail—General Ticket Information;

Passenger Transport Detail—Trip Leg Data;

Passenger Transport Detail—Rail Data;

Vehicle Rental Detail;

Lodging Detail;

Temporary Services;

Shipping/Courier Services;

Electronic Invoice—Transaction Data;

Electronic Invoice—Party Information;

Payment Transaction Addendum Telephony Billing—Summary;

Telephony Billing—Detail;

Travel Agency Detail;

Lodged Account Detail;

Private Label Common Data;

Private Label Line Item;

Healthcare—IIAS Detail;

Corporate Card Common Data Requirements;

Corporate Card Fleet Transaction Information;

Corporate Line Item Detail Generic Detail; or

Any other addenda information known in the art.

Within the above-mentioned addendum information, travel providers may embed personally identifiable information, such as traveler name, traveler birth date, traveler residence address, traveler's telephone number, government identification number (e.g., social security number, passport number, driver's license number, and the like), traveler loyalty program identifier (e.g., frequent flier account identifier, rental car account number, hotel loyalty program number, and the like) or other identifiers.

During the clearing process, payment network 2000 uses the personally identifiable information in the travel addenda, GDS, or BSP information, and matches it to the cardholder name or PII on file with the issuer, or on file with cohabiter data sources in reference about people known to be living with the cardholder, verifying that travel transaction is likely to be legitimate. Conversely, if the personally identifiable information does not match with the cardholder or people known to be living with the cardholder, the payment network 2000 flags the transaction as potentially fraudulent and alerts the fraud investigation department at the payment network 2000, issuer 1400 and/or both.

While the process is discussed in greater detail below, the concepts are best explained by example. Suppose a cardholder purchased a travel-related service from a merchant 1200, such as plane, train, bus, or other travel tickets, hotels, rental-cars and the like. The merchant embeds personally identifiable information within the addenda, GDS, or BSP information, such as a name or frequent flier number. For instance, suppose a frequent flier number is embedded in the addenda, GDS, or BSP information. If the identity of the frequent flier number maps to the cardholder or people living with the cardholder, the transaction is most likely legitimate.

The addenda information can alternatively be supplemented from a Global Distribution System 1500 or other travel data provider. As understood in the art, a Global Distribution System 1500 is generally a network that enables transactions between travel service providers (e.g., airlines, train operators, rental car companies) and travel reservation agents in order to provision travel-related services to end users.

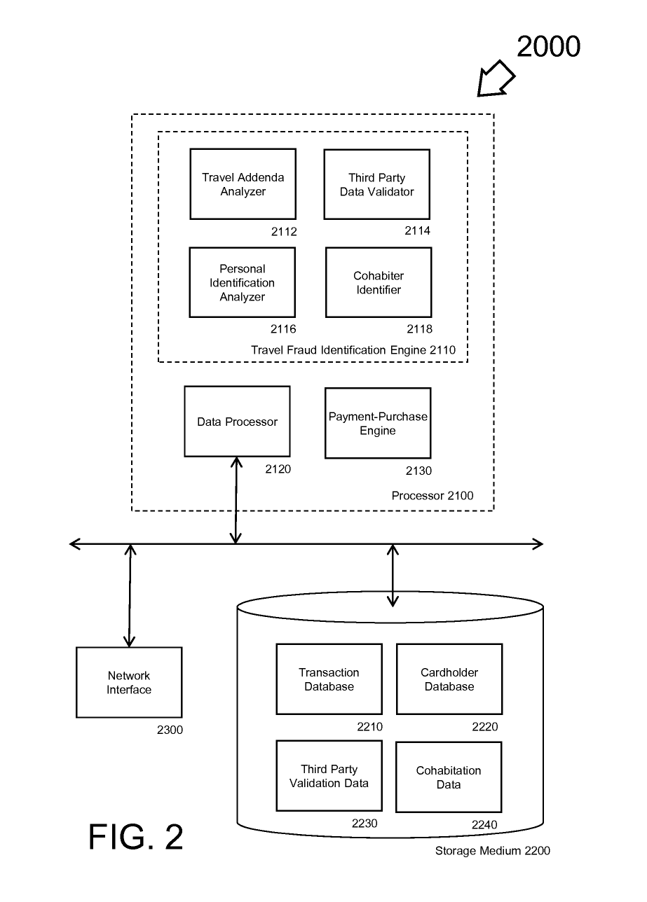

Embodiments will now be disclosed with reference to a block diagram of an exemplary payment network server of FIG. 2, configured to detect payment card fraud in travel transactions, constructed and operative in accordance with an embodiment of the present disclosure.

Payment server may run a multi-tasking operating system (OS) and include at least one processor or central processing unit (CPU) 2100, a non-transitory computer-readable storage media 2200, and a network interface 2300.

Processor 2100 may be any central processing unit, microprocessor, micro-controller, computational device or circuit known in the art. It is understood that processor 2100 may temporarily store data and instructions in a Random Access Memory (RAM) (not shown), as is known in the art.

As shown in FIG. 2, processor 2100 is functionally comprised of a travel fraud identification engine 2110, payment-purchase engine 2130, and a data processor 2120.

Data processor 2120 interfaces with storage media 2200 and network interface 2300. The data processor 2120 enables processor 2100 to locate data on, read data from, and writes data to, these components.

Payment-purchase engine 2130 performs payment and purchase transactions, and may do so in conjunction with travel fraud identification engine 2110.

Travel fraud identification engine 2110 is the structure that receives the transaction information from the acquirer, analyzes the transaction information, and flags a transaction as legitimate or fraudulent where appropriate. Travel fraud identification engine 2110 may further comprise: a travel addenda analyzer 2112, a third party data validator 2114, a personal identification analyzer 2116, and a cohabiter identifier 2118.

Travel addenda analyzer 2112 is configured to extract payment addenda information from transaction data.

Third party data validator 2114 is a structure configured to validate addenda information against third party validation data 2230. Such third party validation data 2230 may be supplemented from a Global Distribution System 1500. In other embodiments, no travel addenda information is received, and only Global Distribution System or BSP data is received.

Personal identification analyzer 2116 is a structure configured to analyze the extracted addenda, GDS, or BSP information of a financial transaction to determine whether personally identifiable information found within the extracted addenda, GDS, or BSP information relates to the cardholder. For example, the personal identification analyzer 2116 may determine that a frequent flier number within the extracted information is the cardholder's frequent flier number. In some instances, the personal identification analyzer 2116 may determine that a frequent flier number found in a transaction is not a cardholder. In such instances, the personal identification analyzer 2116 may reference a cohabiter identifier 2118.

Because cardholders may use their payment card to purchase travel for relatives and other close individuals, it is useful to identify people closely related to the cardholder. In many such instances, the closely related person, such as a spouse, significant other, or child, lives with the cardholder. Cohabiter identifier 2118 is a structure configured to identify non-cardholders referenced in a transaction, and determine whether the person cohabitates (lives with) the cardholder. Cohabiter identifier 2118 may use stored cohabitation data 2240 in the identification.

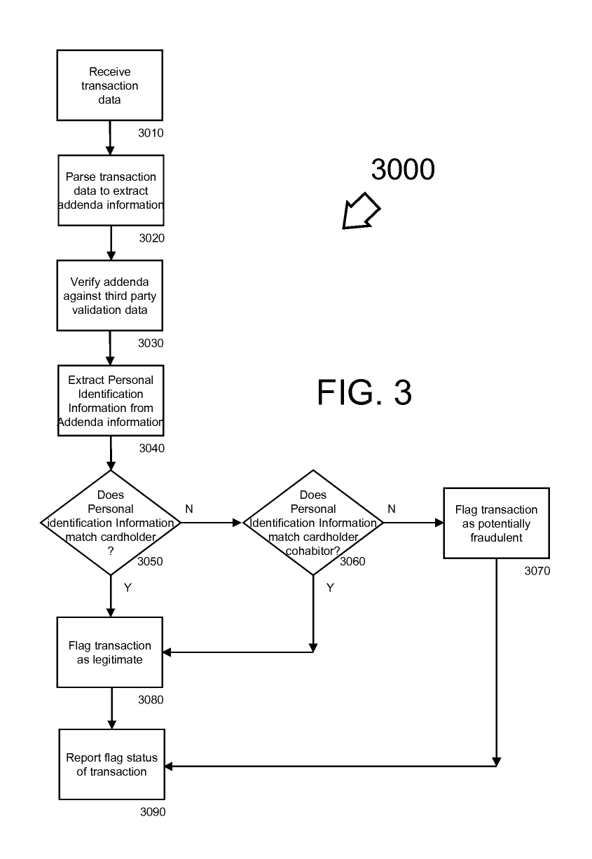

The functionality of all the travel fraud identification engine 2110 structures is elaborated in greater detail in FIG. 3.

These structures may be implemented as hardware, firmware, or software encoded on a computer readable medium, such as storage media 2200. Further details of these components are described with their relation to method embodiments below.

Non-transitory computer-readable storage media 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage media 2200 may be remotely located from processor 2100, and be connected to processor 2100 via a network such as a local area network (LAN), a wide area network (WAN), or the Internet.

In addition, as shown in FIG. 2, storage media 2200 may also contain a transaction database 2210, a cardholder database 2220, third-party validation data 2230, and cohabitation data 2240. Transaction database 2210 stores transaction data received during the clearing process. Cardholder database 2220 stores cardholder information; such cardholder information may include personally identifiable information for cardholders. Third party validation data 2230 is any data known in the art provided by a third party for validation of interchange rates; in some embodiments, the third party validation data 2230 is provided by a Global Distribution System 1500. Moreover, third party validation data 2230 may be used to verify data field validation, data completeness within a transaction, and data accuracy. Cohabitation data 2240 are records of people known to be living together; cohabitation data 2240 may be commercially available cohabitation data. It is understood by those familiar with the art that one or more of these databases 2210-2240 may be combined in a myriad of combinations.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment server to communicate with merchant 1200 and issuer 1400.

We now turn our attention to method or process embodiments of the present disclosure, FIG. 3. It is understood by those known in the art that instructions for such method embodiments may be stored on their respective computer-readable memory and executed by their respective processors. It is understood by those skilled in the art that other equivalent implementations can exist without departing from the spirit or claims of the disclosure.

FIG. 3 illustrates a process 3000 to detect payment card fraud in travel transactions, constructed and operative in accordance with an embodiment of the present disclosure. It is understood by those familiar with the art that process 3000 is a non-real time clearing process, but in alternate embodiments may be a real time process. Conventionally, a clearing process is a non-real time process. Furthermore, it is understood that process 3000 or variations thereof may occur at an issuer 1400 or at a payment network 2000. For the sake of example only, this disclosure will discuss a payment network 2000 embodiment.

At block 3010, payment network 2000 receives transaction data from an acquirer 1300. The transaction data is received electronically via a network interface 2300 and processed using a third party data validator 2114. The transaction data may be part of data from many transactions received via a batch process. The transaction data may contain a cardholder identifier associated with a cardholder, and addenda for the transaction. A cardholder identifier may be a Primary Account Number (PAN) of a payment card used in the transaction. The addenda may contain personally identifiable information for the cardholder or another individual.

At block 3020, the travel addenda analyzer 2112 of the travel fraud identification engine 2110 extracts the associated addenda information from transaction data.

In some instances, the addenda are incomplete. In such instances, travel addenda analyzer 2112 verifies the addenda information against third party validation data 2230, block 3030. Such data may include flight details, such as: origin, destination, carrier, flight number, departure times, travel date, fare class and stopover code information. As part of the verification process, the addenda are corrected and details are added from third party data, if necessary. Note that in cases where GDS data is used to validate addenda data, the GDS records and addenda data may be matched by PAN, transaction date and transaction amount.

In other embodiments, GDS, or BSP information may be used in addition to, or instead of, the addenda information.

At block 3040, personal identification analyzer 2116 extracts and examines any personal identification information from the addenda, GDS, or BSP information.

If the personal identification information matches the cardholder, as determined by the personal identification analyzer 2116 at decision block 3050, and the process continues at block 3080. In some embodiments, the personal identification analyzer 2116 uses the Primary Account Number or other cardholder identifier to retrieve a cardholder record from the cardholder database 2220. The cardholder record may contain personally identifiable information that can verify the identity of the cardholder.

If the personal identification information does not match the cardholder at decision block 3050, the personal identification information is compared to known cohabiters of the cardholder by the cohabiter identifier 2118, block 3060. When the personal identification information does matches a known cohabiter, the cardholder is determined to have likely participated in the transaction and the process continues at block 3080.

When the personal identification information does not match a known cohabiter, the system determines that the cardholder did not likely participate in the payment card transaction. Personal identification analyzer 2116 flags the transaction as potentially fraudulent at block 3070, and the process continues at block 3090.

At block 3080, the transaction is flagged as legitimate. The process continues at block 3090.

At block 3090, the flag status of the transaction is reported. The report may be any electronic reporting method known in the art including an electronic file transfer, electronic mail, a display on a monitor screen, hardcopy printing, or the like.

Process 3000 then ends.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method comprising:
receiving, via a network interface, payment card transaction data from an acquirer or travel transaction data from a Global Distribution System (GDS), the payment card transaction or travel transaction data containing personally identifiable information;
using a cardholder identifier to retrieve a cardholder record from a database stored on a non-transitory computer-readable storage medium;
comparing the personally identifiable information with the cardholder record with a processor to determine whether the cardholder participated in the payment card transaction;
flagging a status of the payment card transaction as fraudulent when the cardholder has not participated in the payment card transaction.

2. The processing method of claim 1, wherein the database further stores cardholder cohabitation information.

3. The processing method of claim 2, wherein the personally identifiable information matches with the cardholder cohabitation information.

4. The processing method of claim 3, wherein the cardholder identifier is a payment card Primary Account Number.

5. The processing method of claim 4, wherein the personally identifiable information is a cardholder name, social security number, frequent traveler number, customer identifier, a date of birth, place of birth, mother's maiden name, or biometric record.

6. The processing method of claim 5, further comprising:
generating a report indicating the flagged status of the payment card transaction.

7. The processing method of claim 6, further comprising:
transmitting, with the network interface, the report indicating the flagged status of the payment card transaction.

8. A system comprising:
a network interface configured to receive payment card transaction data from an acquirer or travel transaction data from a Global Distribution System (GDS), the payment card transaction or travel transaction data containing personally identifiable information;
a processor configured to use the cardholder identifier to retrieve a cardholder record from a database stored on a non-transitory computer-readable storage medium, configured to compare the personally identifiable information with the cardholder record with a processor to determine whether the cardholder participated in the payment card transaction, and configured to flag a status of the payment card transaction as fraudulent when the cardholder has not participated in the payment card transaction.

9. The system of claim 8, wherein the database further stores cardholder cohabitation information.

10. The system of claim 9, wherein the personally identifiable information with the cardholder cohabitation information.

11. The system of claim 10, wherein the cardholder identifier is a payment card Primary Account Number.

12. The system of claim 11, wherein the personally identifiable information is a cardholder name, social security number, frequent traveler number, customer identifier, a date of birth, place of birth, mother's maiden name, or biometric record.

13. The system of claim 12, wherein the processor is further configured to generate a report indicating the flagged status of the payment card transaction.

14. The system of claim 13, wherein the network interface is further configured to transmit the report indicating the flagged status of the payment card transaction.

15. A non-transitory computer readable medium encoded with data and instructions, when executed by a computing device the instructions causing the computing device to:
receive, via a network interface, payment card transaction data from an acquirer or travel transaction data from a Global Distribution System (GDS), the payment card transaction or travel transaction data containing personally identifiable information;
use a cardholder identifier to retrieve a cardholder record from a database stored on the non-transitory computer-readable storage medium;
compare the personally identifiable information with the cardholder record with a processor to determine whether the cardholder participated in the payment card transaction;
flag a status of the payment card transaction as fraudulent when the cardholder has not participated in the payment card transaction.

16. The non-transitory computer-readable medium of claim 15, wherein the database further stores cardholder cohabitation information.

17. The non-transitory computer-readable medium of claim 16, wherein the personally identifiable information with the cardholder cohabitation information.

18. The non-transitory computer-readable medium of claim 17, wherein the cardholder identifier is a payment card Primary Account Number.

19. The non-transitory computer-readable medium of claim 18, wherein the personally identifiable information is a cardholder name, social security number, frequent traveler number, customer identifier, a date of birth, place of birth, mother's maiden name, or biometric record.

20. The non-transitory computer-readable medium of claim 19, wherein the processor is further configured to generate a report indicating the flagged status of the payment card transaction.
